(19) United States
(12) Patent Application Publication
(10) Pub. No.: US 2015/0298951 A1
(43) Pub. Date: Oct. 22, 2015

(54) PALLET LIFT RAILS

(71) Applicant: Rehrig Pacific Company, Los Angeles, CA (US)

(72) Inventors: William P. Apps, Alpharetta, GA (US); Philip A. King, Sugar Hil, GA (US)

(21) Appl. No.: 14/618,654

(22) Filed: Feb. 10, 2015

Related U.S. Application Data
(60) Provisional application No. 61/938,018, filed on Feb. 10, 2014.

(51) Int. Cl. B66F 9/12

(52) U.S. Cl. CPC B66F 9/12

(57) ABSTRACT

A fork tine assembly includes a tine having a support surface and an inner surface. A lift rail is movable between a retracted position and a deployed position. The lift rail provides a lift rail support surface higher than the upper surface of the tine when the lift rail is in the deployed position. The lift rail is not an innermost surface of the tine assembly when the lift rail is in the retracted position and when the lift rail is in the deployed position.

### BACKGROUND

Pallets generally include a deck having an upper surface for supporting goods off the ground. The pallet includes feet or columns for supporting the deck above the ground and for defining space for receiving the forks of a pallet lift.

One existing pallet is typically narrower than standard sized pallets (a “half-size” pallet). It is narrow enough that, when engaged from the short side, the columns of the pallet are received between the forks of the pallet lift and the forks of the pallet lift engage the underside of the deck outward of the columns However, the forks of the pallet are only partially overlapped by the deck, so the forks protrude outward from the deck too. Therefore, if the selected pallet is between two identical pallets, the forks will also engage the bottom surfaces of the decks on either side of the desired pallet, making it difficult to select and remove one pallet from adjacent pallets.

One proposed solution has been to add a lift rail to each of the forks. The lift rails are each connected to one of the forks by hinges on the facing interior surfaces of the forks. When stowed, the lift rails hang down from the hinges adjacent the facing interior surfaces of the forks. For use, the lift rails are rotated upward until the lift rails are on top of the uppermost surfaces of the forks, adjacent the interior edges thereof. When lifting a pallet, the lift rails engage the pallet of the desired pallet before the forks engage the decks of the adjacent pallets. Thus, the desired pallet can be lifted and removed from between adjacent pallets.

### SUMMARY

One drawback of the current design is that the lift rail occupies space between the forks. A fork tine assembly includes a tine having a support surface and an inner surface. A lift rail is movable between a retracted position and a deployed position. The lift rail provides a lift rail support surface higher than the upper surface of the tine when the lift rail is in the deployed position. The lift rail does not decrease the space between the tines in either the retracted or the deployed position.

In one embodiment, the lift rail is elongated and is connected by hinges along the long, lateral edge of the lift rail to the tine. The lift rail is pivoted between a recess in a retracted position and a deployed position.

In another embodiment, the lift rail is pivotably connected at one longitudinal end. The lift rail is generally perpendicular to the tine and is adjacent the lift mechanism when it is in the retracted position. The lift rail is pivoted down onto the tine, parallel to the tine, in the deployed position.

In another embodiment, the lift rail is lifted out of a recess or opening in the tine and pivoted outward on a plurality of pivotably connected arms, pivotably connected at one end to the lift rail at the other end to the tine.

In another embodiment, multiple lift rails on each tine are each lifted from a recess in the tine and then rotated into a deployed position.

### BRIEF DESCRIPTION OF THE DRAWINGS

The drawings can be briefly described as follows:

FIG. 1 is a perspective view of a pallet lift according to one embodiment with the lift rail in the retracted position.

FIG. 2 shows one of the pallet lift tines of FIG. 1 with the lift rail deployed.

FIG. 3 is a perspective view of one half of a pallet lift according to a second embodiment, with the lift rail in a retracted position.

FIG. 4 shows the half pallet lift of FIG. 3 with the lift rail in the deployed position.

FIG. 5 shows a pallet lift tine according to a third embodiment with the lift rail in the retracted position.

FIG. 6 shows the pallet lift tine of FIG. 5 with the lift rail in the deployed position.

FIG. 7 shows a pallet lift tine according to a fourth embodiment with the lift rails in the retracted position.

FIG. 8 shows the pallet lift tine of FIG. 7 with the lift rail in a partially deployed position.

FIG. 9 shows the pallet lift tine of FIG. 7 with the lift rails in the deployed position.

FIG. 10 is a schematic end view showing a pair of tines with deployed lift rails engaging a deck of a pallet between two other pallets.

### DETAILED DESCRIPTION

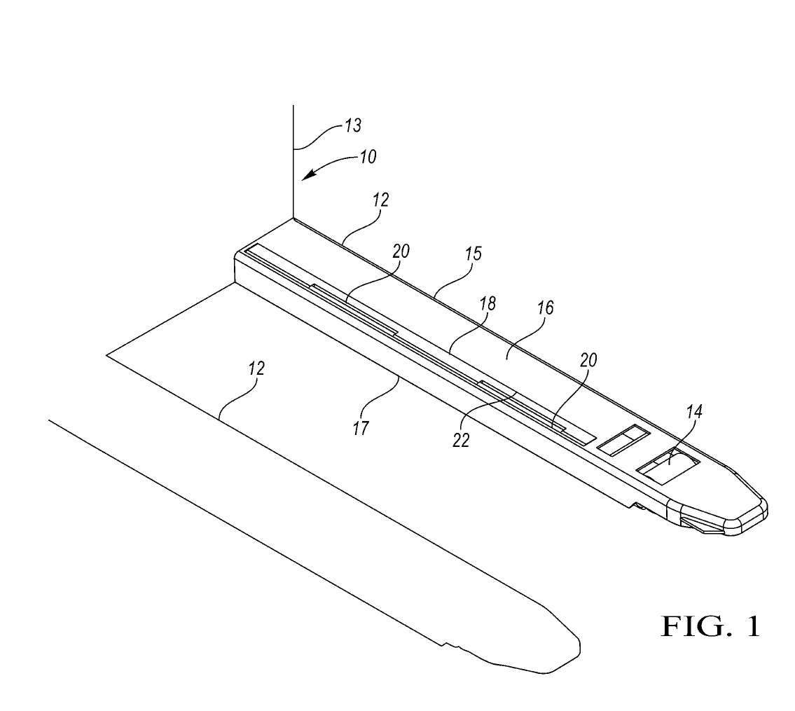

An improved pallet lift 10 is shown in FIG. 1. The pallet lift 10 includes a pair of fork tine assemblies 12 (only one shown in detail here and only one will be shown in the rest of the figures, as the other would be the mirror image) operatively connected to a lift mechanism 13 (the lift mechanism may be hydraulic, electric, etc). The fork tine assembly 12 includes a tine 15 having a forward roller 14 spaced away from the lift mechanism 13. The tine 15 includes an upper support surface 16 and an innermost edge 17 facing the other fork tine assembly 12. The fork tine assembly 12 includes a lift rail 18 secured to the tine 15 by hinges 20 adjacent an inner edge of the tine 15. The hinges 20 connect the long, lateral side of the lift rail 18 to the tine 15 at a point spaced just outside the innermost edge 17 of the tine 15.

In the stowed position of FIG. 1, the lift rail 18 is received in a recess or opening 22 formed in the upper surface 16 of the tine 15. In the stowed, retracted position, the lift rail 18 is not the innermost surface between the fork tine assemblies 12 at any point along the length of the fork tine assemblies 12. The lift rail 18 is spaced outwardly (away from the other fork tine assembly 12) from the innermost surface 17 (i.e. the surface facing the other fork tine assembly 12) of the tine 15. In the retracted position, the upper surface of the lift rail 18 is substantially flush with the uppermost support surface 16 of the tine 15, so that the tine assembly 12 can be used to lift pallets or other items.

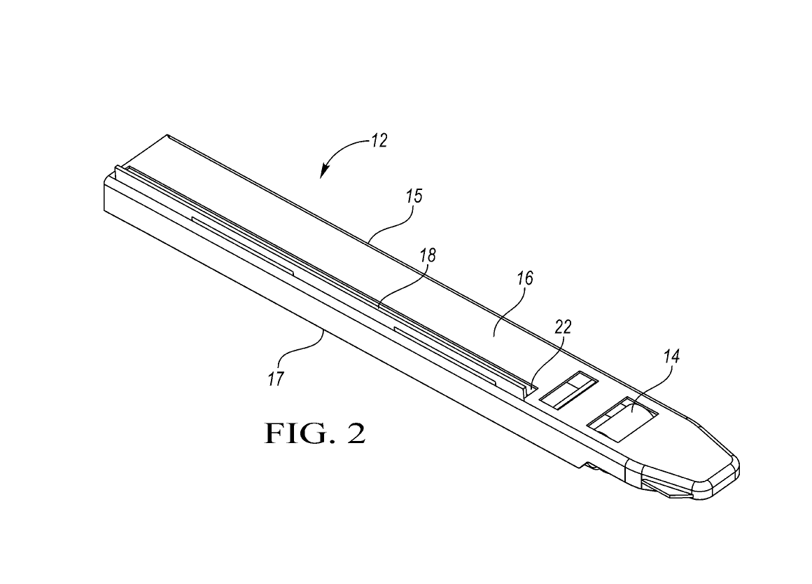

The lift rail 18 can be moved from the retracted position of FIG. 1 to the deployed position of FIG. 2 by pivoting the lift rail 18 about the hinges 20 toward the inner edge of the tine 15, either manually or via an actuator, solenoid or mechanical linkage. In the example shown, the lift rail 18 is rotated slightly more than ninety degrees to the deployed position so that it stays in the deployed position. The lift rail 18 is positioned along the inner edge of the upper surface 16 of each tine 15 so that a pallet can be lifted from adjacent a similar pallet. In the deployed position, the lift rail 18 protrudes upwardly of the upper support surface 16 of the tine 15. The lift rail 18 provides a lift rail support surface higher than the upper support surface 16 of the tine 15 when the lift rail 18 is in the deployed position. In the deployed position, the lift rail 18 is not the innermost surface between the fork tine assemblies 12 at any point along the length of the fork tine assemblies 12. In the deployed position, the lift rail 18 is spaced slightly outwardly (away from the other fork tine assembly 12) from the innermost surface (i.e. the surface facing the other fork tine assembly 12) of the tine 15.

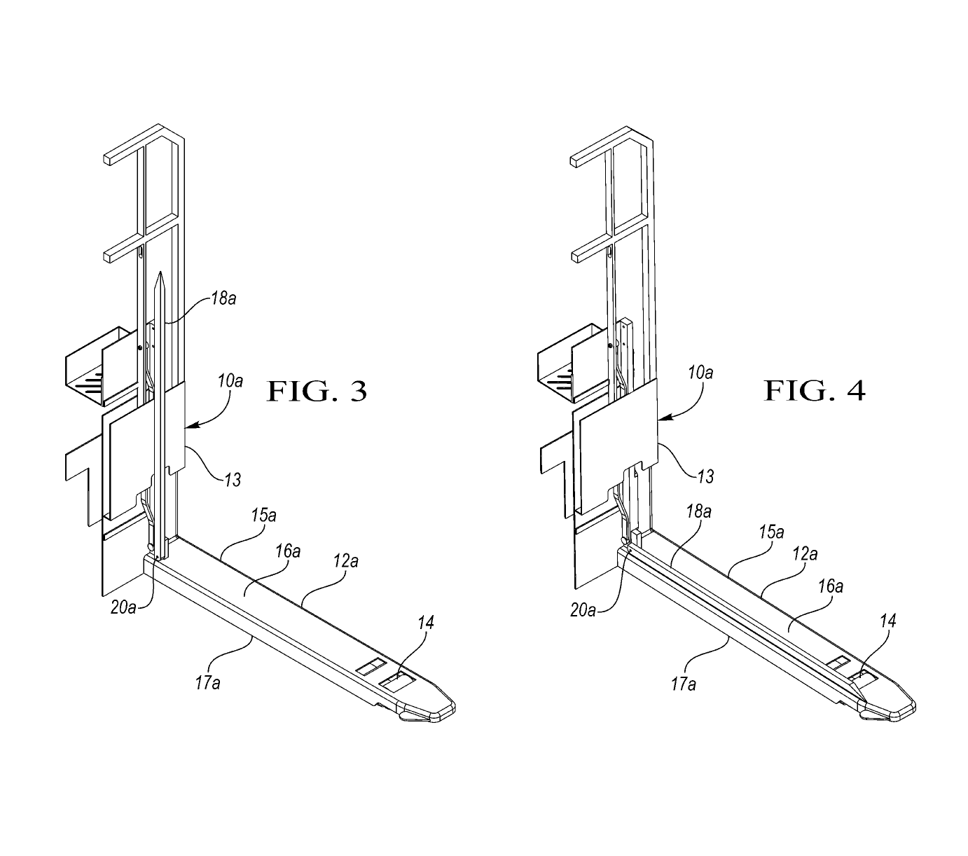

FIGS. 3 and 4 show a lift 10a according to another embodiment. Only one of the two fork tine assemblies 12a is illustrated. The other would be mirror image. The fork tine assembly 12a includes a tine 15a having a roller 14 and an upper surface 16a. The tine 15a has an innermost surface 17a facing the other tine 15a (not shown). In the stowed position shown in FIG. 3, the lift rail 18a is pivoted about a hinge 20a adjacent the lift mechanism to an upright position adjacent the lift mechanism 13. The lift rail 18a may be locked in the upright position by a clip, detent or other lock. In the stowed position, the lift rail 18a is not the innermost surface between the fork tine assemblies 12a at any point along the length of the fork tine assemblies 12a. In the stowed position, the lift rail 18a is spaced outwardly (away from the other fork tine assembly 12a) from the innermost surface 17a (i.e. the surface facing the other fork tine assembly 12) of the tine 15.

To deploy the lift rail 18a, the lift rail 18 is pivoted downward onto the fork tine assembly 12a. The lift rail 18a is on the upper surface 16a of the fork tine assembly 12a adjacent the inner edge thereof so that a pallet can be lifted from adjacent a similar pallet. In the deployed position, the lift rail 18a protrudes upwardly of the upper support surface 16a of the tine 15a. The lift rail 18a provides a lift rail support surface higher than the upper support surface 16a of the tine 15a when the lift rail 18a is in the deployed position. In the deployed position, the lift rail 18a is not the innermost surface between the fork tine assemblies 12a at any point along the length of the fork tine assemblies 12a. In the deployed position, the lift rail 18a is spaced slightly outwardly (away from the other fork tine assembly 12a) from the innermost surface 17a (i.e. the surface facing the other fork tine assembly 12a) of the tine 15a.

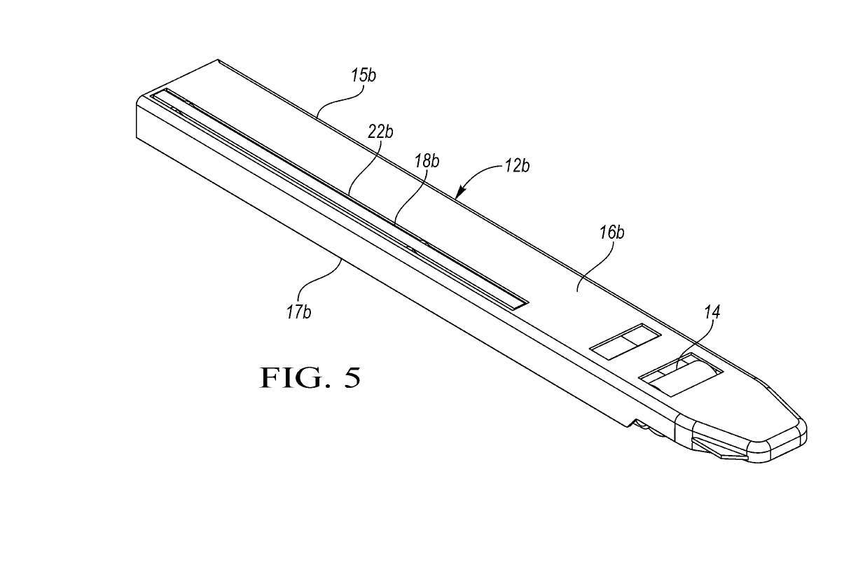

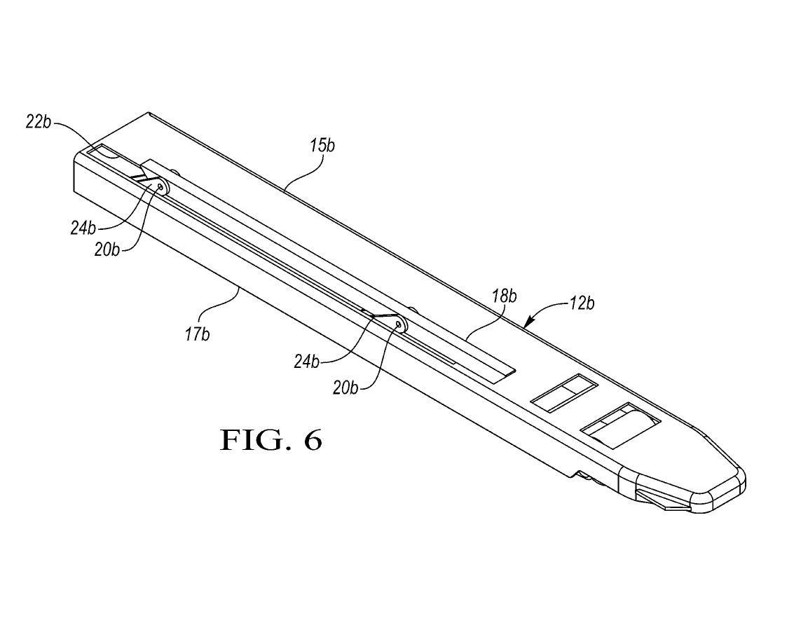

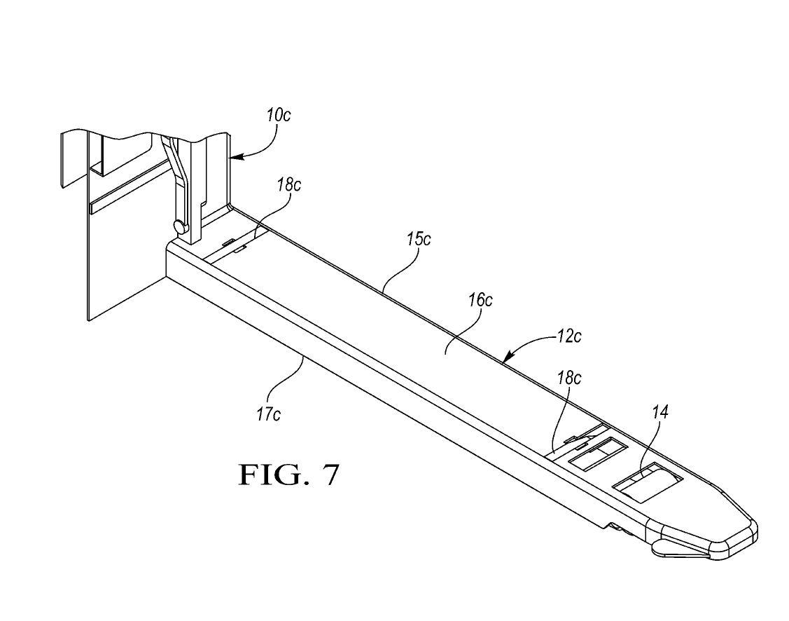

FIGS. 5 and 6 show a fork tine assembly 12b according to another embodiment. The fork tine assembly 12b includes a tine 15b having a roller 14 adjacent an outer end thereof. A retractable lift rail 18b is positioned adjacent an inner edge of the upper surface 16b of the tine 15b. In the stowed position of the FIG. 5, the lift rail 18b is retracted into a recess or opening 22b in the upper surface 16b of the tine 15b. For use, the lift rail 18b is lifted and pulled forward to the deployed position shown in FIG. 6, where it may be locked in place by a detent or latch. The lift rail 18b is lifted out of the recess or opening 22b and pivoted outward on a plurality of pivotably connected arms 24b, pivotably connected at one end to the lift rail 18b at the other end to the tine 15b. In the deployed position, the lift rail 18b protrudes upwardly of the upper support surface 16b of the tine 15b. The lift rail 18b provides a lift rail support surface higher than the upper support surface 16b of the tine 15b when the lift rail 18b is in the deployed position. The lift rail 18b is positioned along the inner edge of the upper surface 16b of each tine 15b so that a pallet can be lifted from adjacent a similar pallet. The lift rail 18b could be moved from the stowed position of FIG. 5 to the deployed position of FIG. 6 manually or by an actuator or by mechanical linkage, such as by a ratchet locking foot pedal (like a parking brake).

FIGS. 7-9 show another embodiment of a pallet lift 10c and fork tine assembly 12c. The fork tine assembly 12c includes a tine 15c having a plurality of lift rails 18c stored flush inside pockets, recesses or openings 22c. The openings 22c are generally perpendicular (or at least transverse) to the inner edge 17c of the tine 15c. The lift rails 18c are flush inside the openings 22c when in the stowed position. In the stowed position, the lift rails 18c are not the innermost surface of the fork tine assemblies 12.

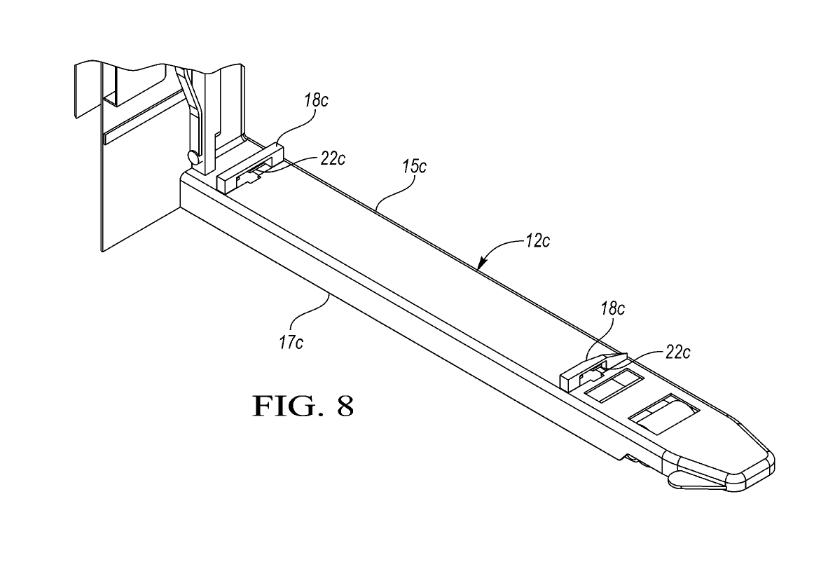

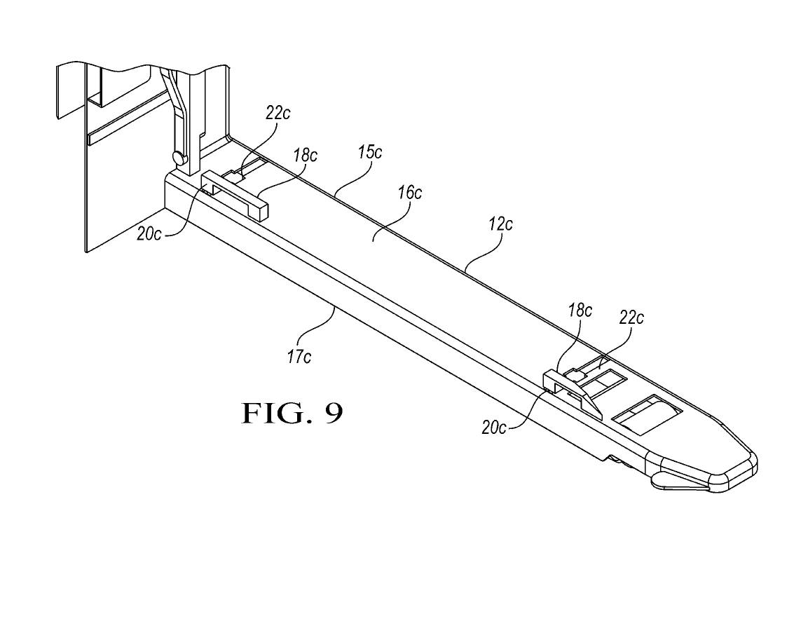

For deployment, the lift rails 18c are first lifted out of their openings 22c as shown in FIG. 8. The lift rails 18c are then rotated 90 degrees to the deployed position shown in FIG. 9. The lift rails 18c in the deployed position are adjacent and parallel to the inner edges of the fork tine assemblies 12c. In the deployed position, the lift rail 18c protrudes upwardly of the upper support surface 16c of the tine 15c. The lift rail 18c provides a lift rail support surface higher than the upper support surface 16c of the tine 15c when the lift rail 18c is in the deployed position. In the deployed position, the lift rails 18c are spaced slightly outwardly of the innermost edge 17c of the tine 15c. The lift rails 18c protrude upwardly of the uppermost support surface of the tine 15c. Although two rails 18c per fork tine assembly 12c are shown, more could be used.

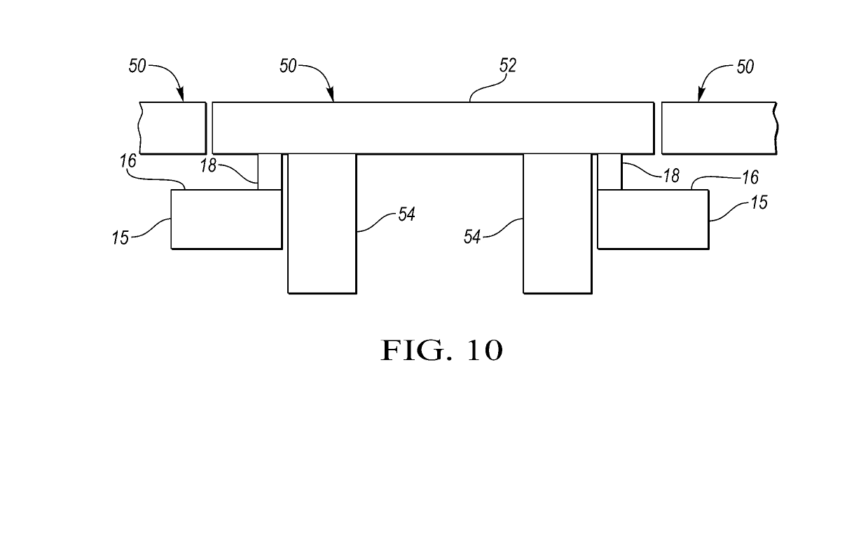

FIG. 10 is a schematic end view showing a pair of tines 16 with deployed lift rails 18 engaging a deck 52 of a pallet 50 between two other pallets 50. The pallets 50 each have a plurality of columns 54 supporting the deck 52. The tines 15 engage the underside of the deck 52 outward of the columns 54. The lift rails 18 provide a smaller uppermost surface so that only one pallet deck 52 is engaged, without engaging the decks 52 of the adjacent pallets 50. FIG. 10 could be the tines 15, 15a, 15b, 15c and lift rails 18, 18a, 18b, 18c of any of the disclosed embodiments, shown generically as tines 15 and lift rails 18.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A fork tine assembly comprising:
a tine having a support surface and an inner surface; and
a lift rail movable between a retracted position and a deployed position, wherein the lift rail provides a lift rail support surface higher than the upper surface of the tine when the lift rail is in the deployed position, wherein the lift rail is not an innermost surface of the tine assembly when the lift rail is in the retracted position and when the lift rail is in the deployed position.

2. The fork tine assembly of claim 1 wherein the lift rail is retractable into a recess on the tine when in the retracted position.

3. The fork tine assembly of claim 1 wherein the lift rail is elongated and is pivotably connected at one lateral edge to the tine.

4. The fork tine assembly of claim 1 wherein the lift rail is retractable into a recess on the tine when in the retracted position, wherein the lift rail is pivotably connected within the recess via at least two arms to the tine.

5. The fork tine assembly of claim 1 wherein the lift rail is a first lift rail and further including a second lift rail movable between a deployed position and a retracted position.

6. The fork tine assembly of claim 1 wherein the lift rail is pivotably connected to the tine.

7. The fork tine assembly of claim 6 wherein the lift rail is retractable into a recess on the tine when in the retracted position.

8. The fork tine assembly of claim 6 further including a roller at an outer end of the tine.

9. The fork tine assembly of claim 1 wherein the lift rail is elongated and is pivotably connected at one longitudinal end to the tine.

10. The fork tine assembly of claim 9 wherein the lift rail is generally perpendicular to the tine in the retracted position.

11. A pallet lift including the fork tine assembly of claim 10 operatively secured to a lift mechanism.

12. A pallet lift including a pair of the fork tine assemblies of claim 10, each operatively secured to a lift mechanism.

13. A pallet lift including the lift rail assembly of claim 1 operatively secured to a lift mechanism.

14. A pallet lift including a pair of the lift rail assemblies of claim 1, each operatively secured to a lift mechanism.

15. A fork tine assembly comprising:
a tine having a support surface; and
an elongated lift rail pivotable about one longitudinal end thereof between a retracted position generally perpendicular to the tine and a deployed position generally parallel to the tine.

16. The fork tine assembly of claim 15 wherein the lift rail provides a lift rail support surface higher than the upper surface of the tine when the lift rail is in the deployed position.

17. The fork tine assembly of claim 16 further including a roller at an outer end of the tine.

18. A pallet lift including the fork tine assembly of claim 16 operatively secured to a lift mechanism.

19. A pallet lift including a pair of the fork tine assemblies of claim 16, each operatively secured to a lift mechanism.
